(19) United States
(12) Patent Application Publication
(10) Pub. No.: US 2009/0231232 A1
(43) Pub. Date: Sep. 17, 2009

(54) External graphic display adapter for express card computer system

(76) Inventor: Wai Keung Chan, Kowloon (CN)

Correspondence Address: ALIX YALE & RISTAS LLP, 750 MAIN STREET, SUITE 1400, HARTFORD, CT, 06103, US

(21) Appl. No.: 12/075,716

(22) Filed: Mar. 13, 2008

(51) Int. Cl. G09G 5/00

(52) U.S. Cl. 345/1.3

(57) ABSTRACT

A display adapter for a portable computer includes an interface module for insertion into an input port of the portable computer. A video output connection may be connected to a display device. A graphic controller is in communication with the interface module and the video output connection. The graphic controller receives display input signals from the portable computer, generates display command signals corresponding to the display input signals, and transmits the display command signals to any display device connected to the video output connection.

### BACKGROUND

This disclosure relates generally to portable computers. More particularly, the present disclosure relates to utilizing multiple monitors with a single portable computer.

Portable computers, such as notebook and tablet computers, have become increasingly popular. In many cases, users have replaced their conventional desktop computer with a portable computer. This has give rise to a demand for features that have traditionally only been available in a desktop computer. These “short comings” that are intrinsic to portable computers include:

1) To be truly portable, the portable computer and its integral display screen are usually relatively small in size. While most portable computers include a port for connecting a larger external monitor, this port is generally a VGA port that may not provide a very high resolution is certainly not digital.

2) Conventional portable computers only provide outputs to two display devices, the integral portable computer display screen and an external monitor connected to the VGA port. Many environments exist in which it is desirable to be able to display data to a number of screens or to display different data to a number of screens from a single location. This data might include video, graphics, text etc. or a mixture of these formats.

3) The graphics controller in a conventional portable computer may be relatively slow to desktop computers, especially for an older portable computer. Portable computer design does not allow for upgrading the graphics controller in the manner of a desktop computer.

### SUMMARY

There is provided a display adapter for a portable computer comprising an interface module for insertion into an ExpressCard slot of the portable computer. A video output connection may be connected to a display device. A graphic controller is in communication with the interface module, without any bridge integrated circuit between the graphic controller and the interface module, and the video output connection. The graphic controller receives display input signals from the portable computer, generates display command signals corresponding to the display input signals, and transmits the display command signals to any display device connected to the video output connection.

The display output port is default as a DVI-I connector, with the graphic controller being a dual graphic controller generating digital and analog display command signals and transmitting the display command signals to the DVI-I connector. However, it may also include any combination of DVI, VGA, TV and any latest display interface such as DisplayPort

The display adapter may further comprise a dual display cable having an input cable that receives the display command signals from the DVI-I connector, a first output cable that transmits the digital display command signals, and a second output cable having a filter separating the digital display command signals from the analog display command signals and transmitting the analog display command signals.

The display adapter may further comprise a connection for an external power source.

The display adapter may further comprise an active cooler assembly having a heatsink and a fan, with the heatsink being thermally connected to the graphic controller ASIC.

The graphic controller is a native graphic controller and the display adapter does not include a bridge IC and circuit for connecting the graphic controller to interface of the portable computer.

### BRIEF DESCRIPTION OF THE DRAWINGS

The present disclosure may be better understood and its numerous objects and advantages will become apparent to those skilled in the art by reference to the accompanying drawings in which:

FIG. 1 is perspective view of a display adapter in accordance with the disclosure;

FIG. 2 is a top view of the display adapter of FIG. 1;

FIG. 3 is a schematic diagram of the adapter of FIG. 1;

FIG. 4 is a schematic diagram of the display output configuration;

FIG. 5 is a schematic diagram of the adapter connecting two video displays to a portable computer.

### DETAILED DESCRIPTION

With reference to the drawings wherein like numerals represent like parts throughout the several figures, a display adapter in accordance with the present disclosure is generally designated by the numeral 10. The display adapter 10 provides many of the advantages of a desktop computer environment, while maintaining the portability of a portable computer.

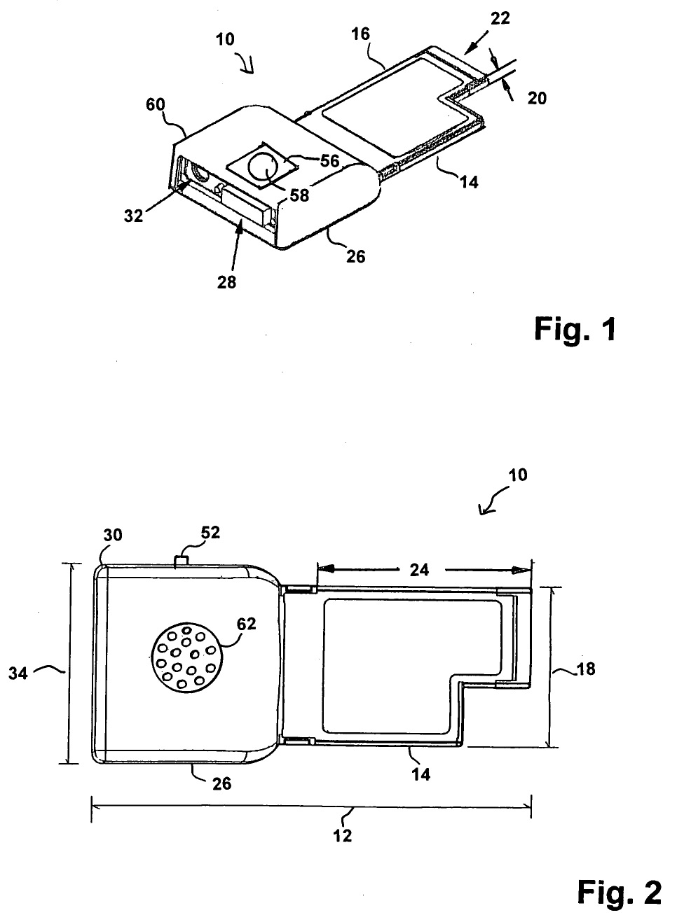

With reference to FIGS. 1 and 2, the display adapter 10 complies with the ExpressCard™ specifications. In the embodiment shown in FIGS. 1 and 2, the display adapter 10 has a length 12 of 150 mm. A first end portion 14 has a computer interface module 16 complying with the ExpressCard™ 54 form factor, for insertion into a corresponding slot in the portable computer. To ensure compatibility with the slots included with conventional portable computers, the first end portion 14 has a width 18 of 54 mm and a thickness 20 of 5 mm. To ensure that the 26 pin connector 22 at the proximal end of the first end portion 14 engages the mating connector of the portable computer, the first end portion 14 has a length 24 of 76 mm. The second end portion 26 includes a conventional DVI-I connector 28 at the distal end 30. The distal end 30 of the second end portion 26 may also include a television output or display port connection 32. In the embodiment of FIG. 1, the second end portion 26 has a width 34 of 75 mm.

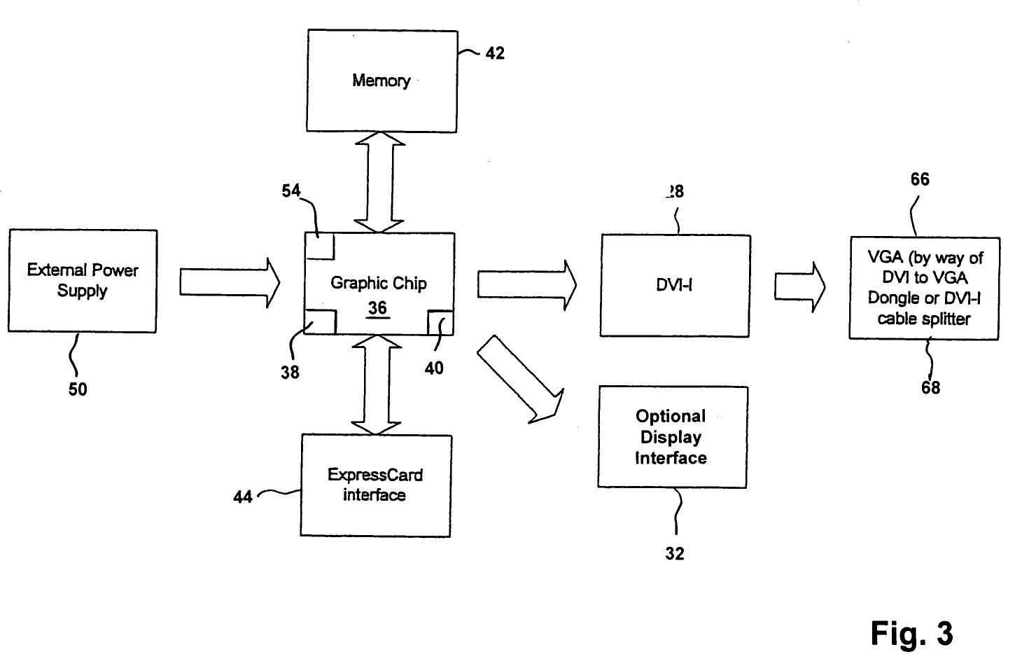

With reference to FIG. 3, the display adaptor 10 includes an application specific integrated circuit (ASIC) graphic controller 36 with two display engines 38, 40 and at least one memory 42. The graphic controller 36 may be a native graphic controller that connects to the ExpressCard™ interface 44 of the portable computer 46 via connector 22 and the mating connector of the portable computer 46 without any bridge IC in between. The graphic controller 36 receives display input signals from the portable computer 46 via the interface module 16, generates digital and analog display command signals corresponding to the display input signals with the display engines 38 and 40, and transmits the display command signals to display devices 48 connected to the video output connections 28, 32. Due to the power supply limits imposed by the ExpressCard™ specifications, the display adapter 10 requires an external power source 50. Accordingly, the display adapter 10 includes a connector 52 for receiving power from an external power supply or a USB cable. An active cooler assembly 54 having a heatsink 56 and a fan 58 is mounted to the top of the graphic controller 36 inside the display adaptor housing 60 with the heatsink 56 thermally connected to the graphic controller 36. The heat removed by the cooler assembly 54 is exhaust through ventilation openings 62 in the adapter housing 60.

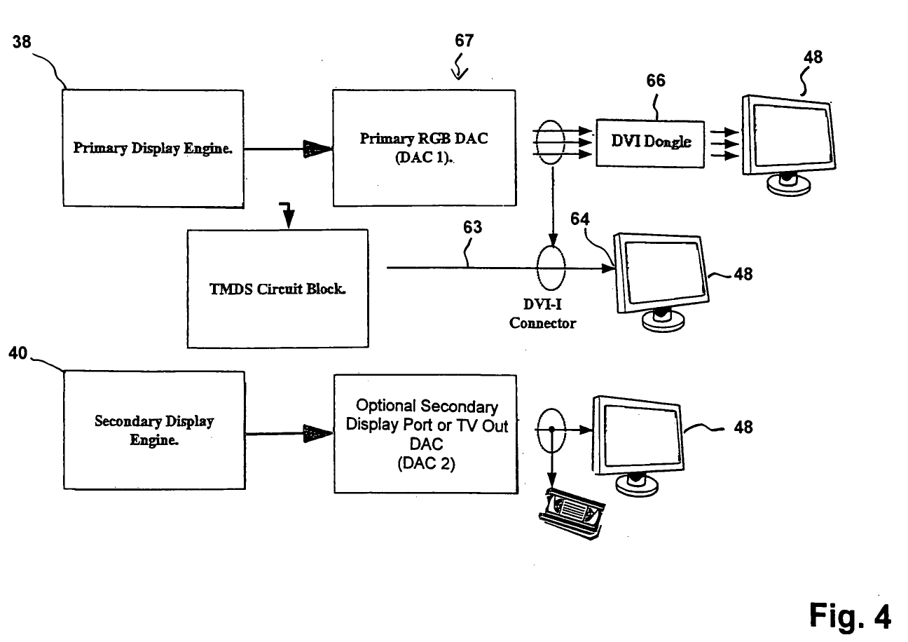

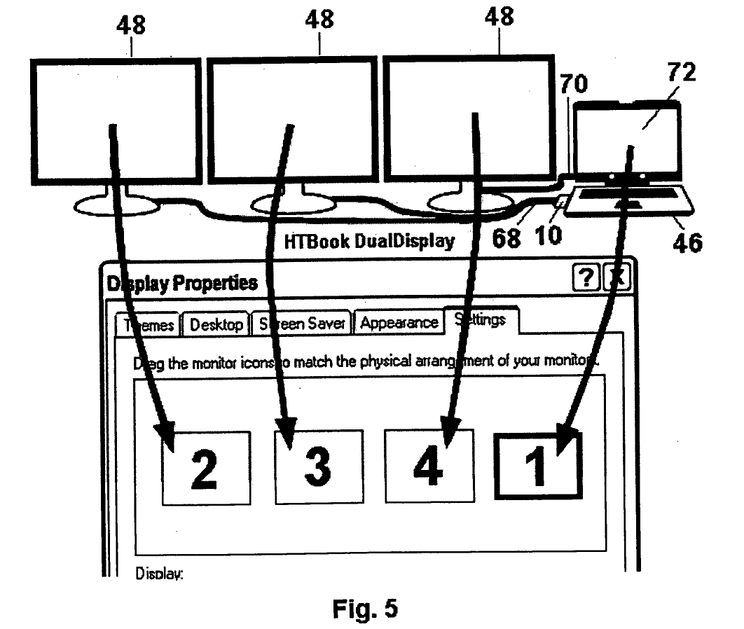

With reference to FIG. 4, the DVI-I output connector 28 and the television output or display port connector 32 support several different methods for connecting displays 48 to the display adapter 10. The DVI-I output connector 28 may be connected 63 to the DVI-d input 64 of a digital display device 48, providing one additional display. The DVI-I output connector 28 may be connected 67 to an analogue display 48 device using a DVI dongle 66 that separates the digital display command signals from the analog display command signals and transmits the analog display command signals, providing one additional display. With additional reference to FIG. 5, two additional displays 48 may be simultaneously connected by a dual display cable 68 to the DVI-I output connector 28. A digital display device 48 is connected to the cable 68 by a digital DVI-d input and an analogue display device 48 is connected to the cable 68 by a VGA input. Another display device 48 may be connected to the television output or display port connection 32 while a second display 48 device is simultaneously connected to the DVI-I output connector 28. This second display device 48 may be a digital device connected by a DVI-d input connector 68 or an analogue device connected by a DVI dongle 66.

Using the dual display cable 68 or the DVI-I output connector 28 and the television output connector 32, along with the portable computer external video output 70 allows three external video displays 48 to be connected to the portable computer 46. This gives a grand total of four displays including the portable computer's integral display 72. As shown in FIG. 5, with the suitable display drivers, it's possible to choose between a unified screen space or a true multiple head solution compatible with any kind of multi display application.

It should be appreciated that the display adapter 10 provides a high performance graphic solution for portable computers through the ExpressCard™ slot that is available in such computers. The display adapter 10 supports enhanced multi-display function, transforming the portable computer 46 into a multi display workstation. The display adapter 10 has a dual link DVI connector 28 supporting the highest resolution found in the newest display devices 48. The display adapter 10 has a very small form factor and a light weight design providing high mobility. The display adapter 10 supports both Window XP and Vista.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A display adapter for a portable computer having an ExpressCard slot, the display adapter comprising:
an interface module adapted for insertion into the ExpressCard slot of the portable computer and to communicate with an interface of the portable computer;
a video output connection adapted for connection to a display device; and
a graphic controller in communication with the interface module without any bridge integrated circuit disposed intermediate the graphic controller and the interface module, the graphic controller
being adapted receive display input signals from the portable computer,
generate display command signals corresponding to the display input signals, and
transmit the display command signals to the video output connection.

2. The display adapter of claim 1 wherein the video output connection comprises a DVI-I connector and the graphic controller is a dual graphic controller generating digital display command signals and analog display command signals and transmitting the display command signals to the DVI-I connector.

3. The display adapter of claim 2 wherein the video output connection also comprises a television output or a display port connection.

4. The display adapter of claim 2 further comprising a dual display cable, the dual display cable including an input cable receiving the display command signals from the DVI-I connector, a first output cable transmitting the digital display command signals, and a second output cable transmitting the analog display command signals.

5. The display adapter of claim 1 wherein the interface module has an ExpressCard form factor in 54 mm.

6. The display adapter of claim 5 wherein the display adapter has a length substantially equal to 150 mm and a width substantially equal to 75 mm.

7. The display adapter of claim 5 wherein the interface module includes a 26 pin connector adapted for connecting to an associated 26 pin connector of the portable computer.

8. The display adapter of claim 1 further comprising a connection for an external power source.

9. The display adapter of claim 1 further comprising an active cooler assembly having a heatsink and a fan, the heatsink being thermally connected to the graphic controller ASIC.

10. The display adapter of claim 1 wherein the graphic controller is a native graphic controller.

11. The display adapter of claim 1 wherein the graphic controller is an ASIC integrated circuit.
